(19) United States
(12) Patent Application Publication
(10) Pub. No.: US 2026/0280715 A1
(43) Pub. Date: Sep. 17, 2026

(54) LASER SOURCE TRANSMISSION SYSTEM AND MANUFACTURING METHOD OF THE SAME

(71) Applicant: AuthenX Inc., Zhubei City (TW)

(72) Inventors: Jun-Rong CHEN, Zhubei City (TW); Chun-Chiang YEN, Zhubei City (TW); Po-Kuan SHEN, Zhubei City (TW); Jenq-Yang CHANG, Zhubei City (TW); Mao-Jen WU, Zhubei City (TW)

(73) Assignee: AuthenX Inc., Zhubei City (TW)

(21) Appl. No.: 19/558,631

(22) Filed: Mar. 6, 2026

Related U.S. Application Data
(60) Provisional application No. 63/772,014, filed on Mar. 14, 2025.

(51) Int. Cl. H04B 10/50; G02B 6/38; G02B 6/42

(52) U.S. Cl. CPC H04B 10/503; G02B 6/3812; G02B 6/3846; G02B 6/3871; G02B 6/421; G02B 6/4226

(57) ABSTRACT

An external laser source transmission system includes multiple external laser source transmission modules, a system substrate and multiple optical connecting elements. The system substrate is configured to carry the external laser source transmission modules. Each external laser source transmission module includes a light emitting assembly, a polarization-maintaining fiber assembly and an adaptor. The light emitting assembly includes a substrate and a molding element used to mold a laser, a lens, an isolator and the substrate. The polarization-maintaining fiber assembly is engaged with the light emitting assembly, and the polarization-maintaining fiber assembly includes a polarization-maintaining fiber and a cylindrical enclosing member. The adaptor is engaged with the light emitting assembly and the cylindrical enclosing member. The cylindrical enclosing member rotates relative to the adaptor to optimize polarization extinction ratio. The optical connecting elements are coupled to the polarization-maintaining fibers of the multiple external laser source transmission modules.

### CROSS - REFERENCE TO RELATED APPLICATION

This application claims priority to US Provisional Application Serial Number 63/772,014, filed Mar. 14, 2025, which is herein incorporated by reference in its entirety.

### BACKGROUND

### FIELD OF INVENTION

The present invention relates to an external laser source transmission system and the manufacturing method of the external laser source transmission system.

### DESCRIPTION OF RELATED ART

To meet the demands of rapid technological developments in generative AI which result in mass data computation and transmission requirements, external laser source (ELS) transmission systems for silicon photonic integrated circuits are a common choice for mass production within co-packaged optics technology.

External laser source transmission systems utilize polarization-maintaining fibers for optical signal transmission, and the optical axis direction of the fibers must be aligned with the polarization direction of the laser light. Conventional methods of connecting light emitting assemblies to optical fibers employ multi-channel simultaneous docking, which makes it impossible to monitor and adjust the optical axis direction of the polarization-maintaining fibers individually in real-time during assembly process. The entire module needs to be replaced when poor transmission efficiency in any single fiber or light emitting assembly occurs, which results in difficulties of mass production and yield improvement.

Accordingly, it is still a goal of research and development in this field to provide an external laser source transmission system that can solve the problems mentioned above.

### SUMMARY

One aspect of the disclosure is an external laser source transmission system.

In one embodiment, the external laser source transmission system includes multiple external laser source transmission modules, a system substrate and multiple optical connecting elements. Each of the external laser source transmission modules includes a light emitting assembly, a polarization-maintaining fiber assembly and an adaptor. The light emitting assembly includes a substrate and a molding element, and the substrate is configured to carry the laser, the lens and the isolator. The molding element is used to mold a laser, a lens, an isolator and the substrate. The polarization-maintaining fiber assembly is engaged with the light emitting assembly, and the polarization-maintaining fiber assembly includes a polarization-maintaining fiber and a cylindrical enclosing member. The adaptor is engaged with the light emitting assembly and the cylindrical enclosing member. The cylindrical enclosing member rotates relative to the adaptor to optimize polarization extinction ratio. The system substrate is configured to carry the external laser source transmission modules. The multiple optical connecting elements are coupled to the polarization-maintaining fibers of the multiple external laser source transmission modules.

Another aspect of the disclosure is a manufacturing method of an external laser source transmission system.

In one embodiment, the manufacturing method of an external laser source transmission system includes mounting at least one external laser source transmission module and engaging the light emitting assembly and the cylindrical enclosing member through an adaptor, wherein the cylindrical enclosing member rotates relative to the adaptor to optimize polarization extinction ratio. Mounting at least one external laser source transmission module includes forming a light emitting assembly, mounting a first side of at least one polarization-maintaining fiber in a cylindrical enclosing member, and coupling a second end of the at least one polarization-maintaining fiber in an optical connecting element. Forming the light emitting assembly includes molding a substrate with a laser, a lens, and an isolator on the substrate through a molding element.

In the aforementioned embodiments, the external laser source transmission system disclosed herein utilizes a cylindrical enclosing member that can rotate relative to the adaptor to rotate the polarization-maintaining fiber relative to the adaptor, thereby aligning the optical axis direction of the polarization-maintaining fiber with the optical polarization direction of the laser and optimizing polarization extinction ratio. Rotating the larger cylindrical enclosing member can reduce the difficulty of adjusting the optical axis direction of the polarization-maintaining fiber. Furthermore, the adaptor along with the polarization-maintaining fiber assembly can move relative to the emitting light assembly to optimize optical coupling intensity. Since the external laser source transmission modules disclosed herein are all independent from each other, the light emitting assemblies can be placed on the system substrate in different placement orientations. As such, it can increase the flexibility of placement positions and reduce the system area. The assembly process of the external laser source transmission module disclosed herein is modular and operates independently, and therefore mass packaging and production are available. During assembly process, the laser emission can be detected in real time to optimize optical coupling intensity and polarization extinction ratio, and specific damaged components can be replaced. Such design is beneficial for assembly convenience and yield.

### BRIEF DESCRIPTION OF THE DRAWINGS

The invention can be more fully understood by reading the following detailed description of the embodiment, with reference made to the accompanying drawings as follows:

FIG. 1A is a schematic diagram of an external laser source transmission system 100 according to an embodiment of the present disclosure.

FIG. 1B is a cross-sectional view taken along the line 1B-1B in FIG. 1A.

FIG. 2 is a schematic diagram of the polarization-maintaining fiber assembly in FIG. 1A.

FIG. 3 is a schematic diagram of the cylindrical enclosing member and the adaptor in FIG. 1A before engagement.

FIG. 4 is a schematic diagram of the cylindrical enclosing member and the adaptor in FIG. 3 after engagement.

FIG. 5 is a cross-sectional view taken along the line 5-5 in FIG. 4.

FIG. 6 is a schematic diagram of the cylindrical enclosing member and the adaptor before engaged to the light emitting assembly according to another embodiment of the present disclosure.

FIG. 7 is a schematic diagram of the cylindrical enclosing member and the adaptor after engaged to the light emitting assembly according to FIG. 6.

FIG. 8 is a schematic diagram of an external laser source transmission system according to another embodiment of the present disclosure.

FIG. 9 is a schematic diagram of an external laser source transmission system according to another embodiment of this disclosure.

FIG. 10 is a schematic diagram of the cylindrical enclosing member in FIG. 9 before engaged to the adaptor.

FIG. 11 is a schematic diagram of the cylindrical enclosing member in FIG. 10 after engaged to the adaptor.

FIG. 12 is a schematic diagram of an external laser source transmission system 100d according to another embodiment of the present disclosure.

FIG. 13 is a schematic diagram of an external laser source transmission system 100e according to another embodiment of the present disclosure.

FIG. 14A is a schematic diagram of an external laser source transmission system 100f according to another embodiment of the present disclosure.

FIG. 14B is a cross-sectional view taken along the line 14B-14B in FIG. 14A.

FIG. 15A is a schematic diagram of an external laser source transmission system according to another embodiment of the present disclosure.

FIG. 15B is a cross-sectional view taken along the line 15B-15B in FIG. 15A.

FIG. 16 is a schematic diagram of an external laser source transmission system according to another embodiment of the present disclosure.

FIG. 17 is a schematic diagram of the step of connecting the polarization-maintaining fiber assembly and the light emitting assembly in FIG. 1A.

FIG. 18 is a schematic diagram of an external laser source transmission system connected to a silicon photonic integrated circuit according to an embodiment of this disclosure.

FIG. 19 is a schematic diagram of the step of connecting the polarization-maintaining fiber assembly and the light emitting assembly in FIG. 9.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

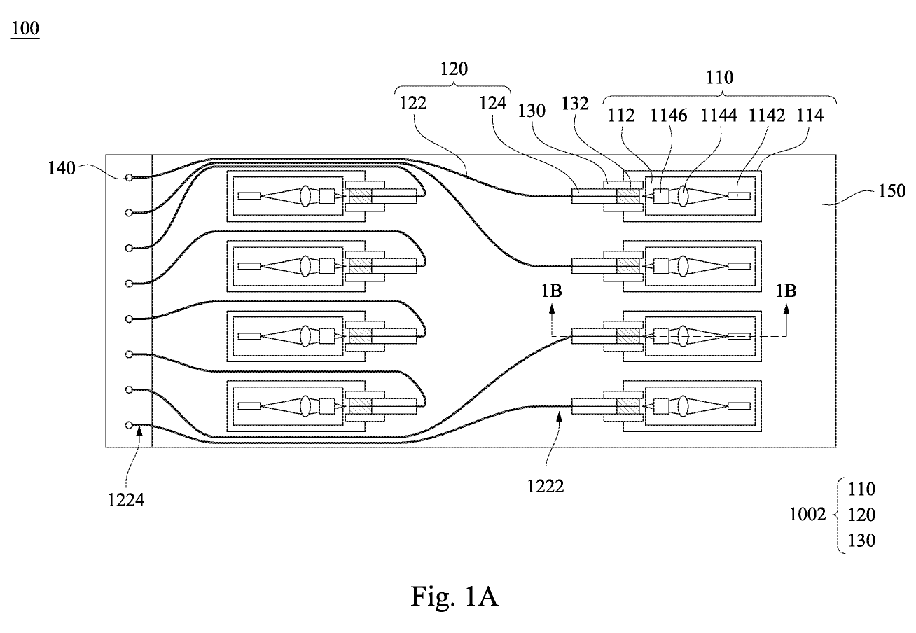

FIG. 1A is a schematic diagram of an external laser source transmission system 100 according to an embodiment of the present disclosure. FIG. 1B is a cross-sectional view taken along the line 1B-1B in FIG. 1A. The external laser source transmission system 100 includes multiple light emitting assemblies 110, multiple polarization-maintaining fiber assemblies 120, multiple adaptors 130, multiple optical connecting elements 140, and a system substrate 150.

Each of the light emitting assemblies 110 includes a substrate 112 and a molding element 114. Each of the molding elements 114 encapsulates a laser 1142, a lens 1144, an isolator 1146, and the substrate 112. The substrate 112 carries the laser 1142, the lens 1144, and the isolator 1146.

The polarization-maintaining fiber assemblies 120 are respectively connected to the light emitting assemblies 110. Each of the polarization-maintaining fiber assemblies 120 includes a polarization-maintaining fiber 122 and a cylindrical enclosing member 124. The two ends of the adaptors 130 are respectively connected to the light emitting assemblies 110 and the cylindrical enclosing members 124. The optical connecting elements 140 are configured to connect the polarization-maintaining fibers 122.

The module assembled from a light emitting assemblies 110, a polarization-maintaining fiber assembly 120, and an adaptor 130 will be described below as an external laser source transmission module 1002. In this embodiment, eight modules are demonstrated as an example, but the present disclosure is not limited thereto. The system substrate 150 is configured to carry multiple external laser source transmission modules 1002 to form a single external laser source transmission system 100.

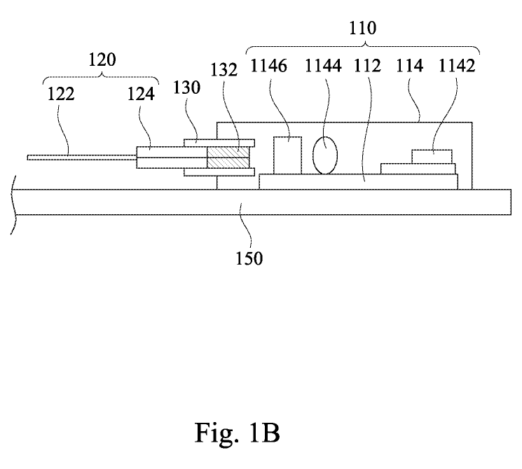

FIG. 2 is a schematic diagram of the polarization-maintaining fiber assembly 120 in FIG. 1A. In the present embodiment, the cylindrical enclosing member 124 may be a ferrule, but the present disclosure is not limited thereto. The first end 1222 of the polarization-maintaining fiber 122 is mounted inside the cylindrical enclosing member 124. The first end 1222 of the polarization-maintaining fiber 122 is fixed relative to the cylindrical enclosing member 124.

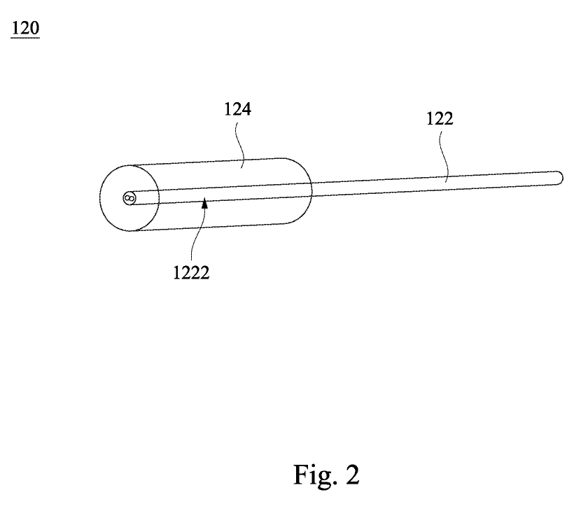

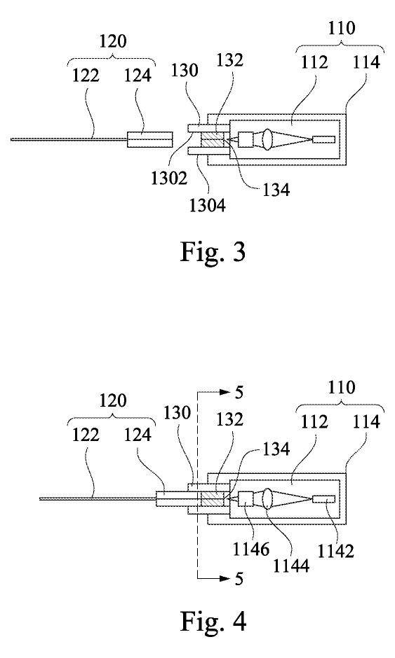

FIG. 3 is a schematic diagram of the cylindrical enclosing member 124 and the adaptor 130 in FIG. 1A before engagement. FIG. 4 is a schematic diagram of the cylindrical enclosing member 124 and the adaptor 130 in FIG. 3 after engagement. The adaptor 130 has a circular inner wall 1302 and a circular outer wall 1304. Reference is made to FIG. 3, the adaptor 130 is an assembly that includes a fiber stub 132. The fiber stub 132 includes a short optical fiber 134 for transmitting laser light, and the short optical fiber 134 has been pre-adjusted relative to the light emitting assembly 110 for an optimized optical coupling intensity (not shown in FIG. 3).

Reference is made to FIGS. 3 and 4, the fiber stub 132 is configured to abut against the cylindrical enclosing member 124, which is pluggably mounted into the circular inner wall 1302. The cylindrical enclosing member 124 can rotate relative to the fiber stub 132 after being engaged to the adaptor 130, thereby optimizing polarization extinction ratio of the laser light received by the polarization-maintaining fiber 122. The laser light is transmitted to the polarization-maintaining fiber 122 mounted in the cylindrical enclosing member 124 through the short fiber 134 within the fiber stub 132.

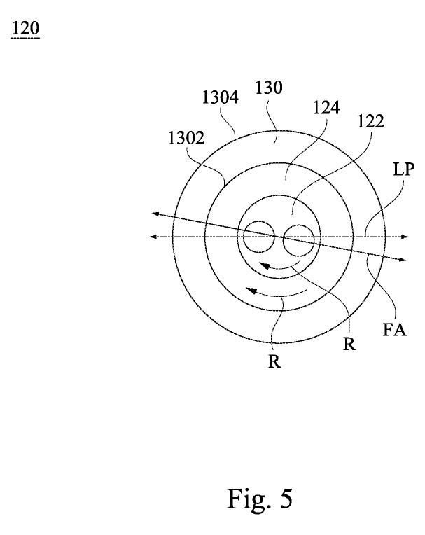

FIG. 5 is a cross-sectional view taken along the line 5-5 in FIG. 4. Reference is made to FIG. 4 and FIG. 5, the light beam from the laser 1142 has an optical polarization direction LP, and the polarization-maintaining fiber 122 has an optical axis direction FA. The cylindrical enclosing member 124 in the present disclosure is utilized to rotate the polarization-maintaining fiber 122 to align the optical axis direction FA of the polarization-maintaining fiber 122 with the optical polarization direction LP of the laser 1142. In other embodiments, the polarization-maintaining fiber 122 and the cylindrical enclosing member 124 can be rotated together by rotating the adaptor 130. When the optical axis direction FA overlaps the optical polarization direction LP, an optimal polarization extinction ratio can be achieved.

Compared to the traditional method of rotating an optical fiber with a diameter of approximately 125 micrometers to align the optical axis, the cylindrical enclosing member 124 with a diameter of approximately 1.25 millimeters is utilized in the present disclosure. In other words, rotating the larger cylindrical enclosing member 124 reduces the difficulty of adjusting the optical axis direction FA of the polarization-maintaining fiber 122. The present embodiment is a light emitting assembly 110 that includes the adaptor 130, which has pluggable function. During the packaging process, the adaptor 130 that is not connected to the optical fiber can be retained, and the downstream manufacturers perform the process of engaging the polarization-maintaining fiber 122.

Reference is made to FIG. 1A. The optical connecting elements 140 can be a Multi-fiber Push-on connector (MPO), a Multi-fiber Termination Push-on connector (MTP), or an MT stub, but the present disclosure is not limited thereto.

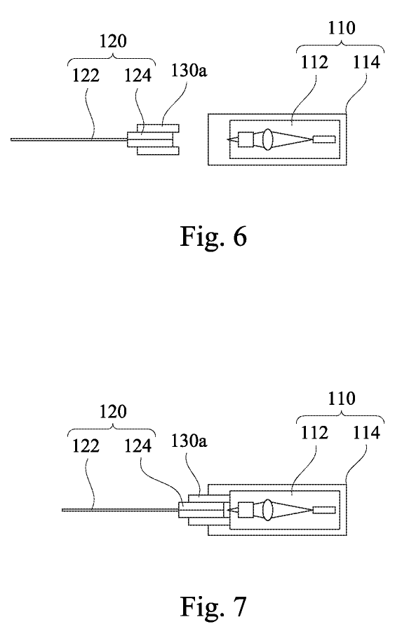

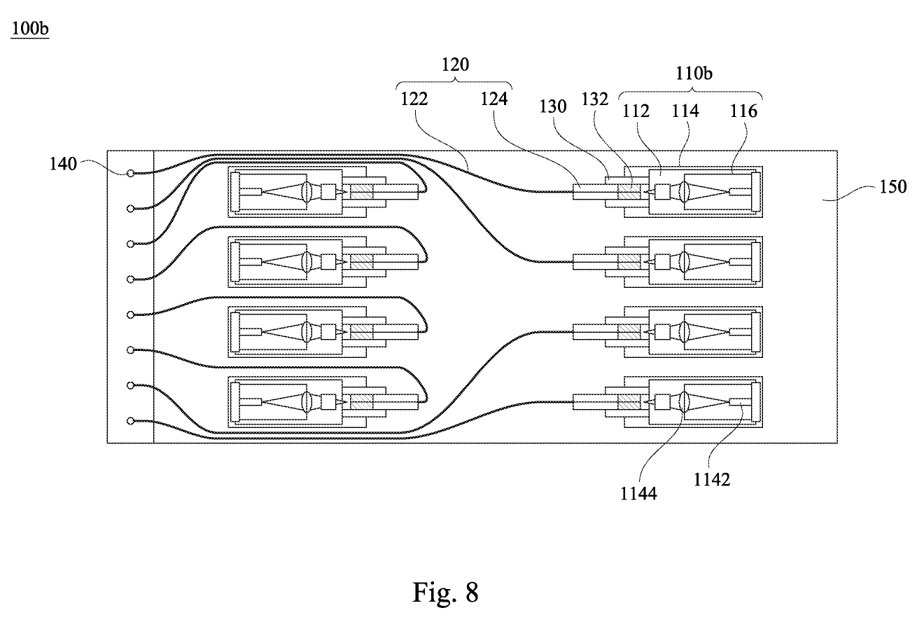

FIG. 6 is a schematic diagram of the cylindrical enclosing member 124 and the adaptor 130a before engaged to the light emitting assembly 110 according to another embodiment of the present disclosure. FIG. 7 is a schematic diagram of the cylindrical enclosing member 124 and the adaptor 130a after engaged to the light emitting assembly 110 according to FIG. 6. In the present embodiment, the cylindrical enclosing member 124 is first mounted into the adaptor 130a, which is a leading-line assembly. Such assembly directly receives laser light from the light emitting assembly 110. Relative to the laser light, the polarization-maintaining fiber 122 and the cylindrical enclosing member 124 are driven by rotating the adaptor 130a. When the optical axis direction FA overlaps the optical polarization direction LP, the optimal polarization extinction ratio can be achieved. The adaptor 130a of the present embodiment has similar technical advantages to the adaptor 130 in the embodiment of FIG. 1A, and will not be described again hereinafter.

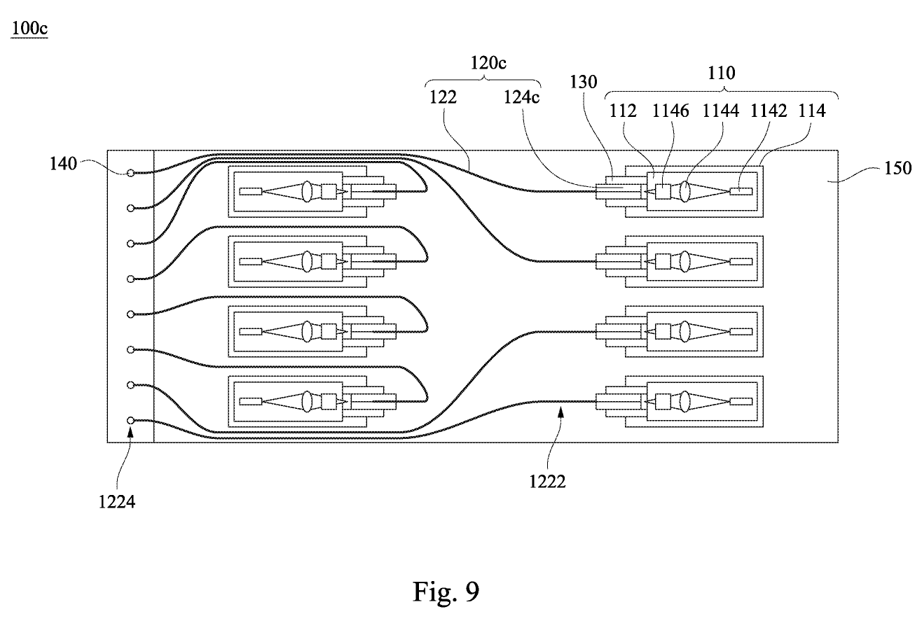

FIG. 8 is a schematic diagram of an external laser source transmission system 100b according to another embodiment of the present disclosure. The external laser source transmission system 100b is similar to the external laser source transmission system 100 in FIG. 1A, and the difference is that each light emitting element 110b further includes a can-shaped package 116 configured to first encapsulate the laser 1142 and lens 1144 to form a sub-module. During the packaging process, the structure of the sub-module is beneficial for improving production rate and achieving rapid replacement of damaged components, thereby improving yield. The external laser source transmission system 100b has the same technical advantages as the external laser source transmission system 100 of FIG. 1A, and will not be described again hereinafter.

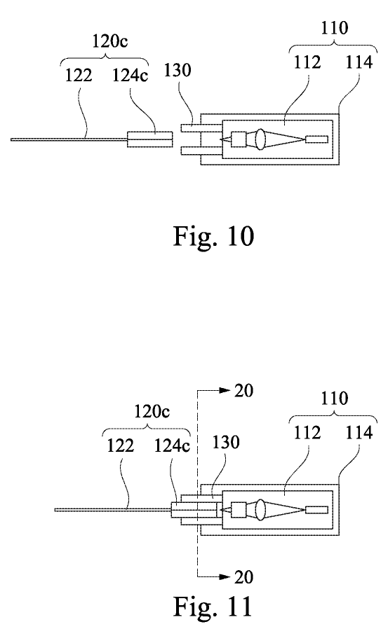

FIG. 9 is a schematic diagram of an external laser source transmission system 100c according to another embodiment of this disclosure. The external laser source transmission system 100c is similar to the external laser source transmission system 100 in FIG. 1A, and the difference is that the adaptor 130 only includes a polarization-maintaining fiber assembly 120c and there is no fiber stub. In the present embodiment, the cylindrical enclosing member 124c and the polarization-maintaining fiber 122 can be driven to rotate together by rotating the adaptor 130 so as to optimize optical coupling intensity and optimize polarization extinction ratio relative to the light emitting assembly 110. Users can replace different configurations of the adaptor 130 in the external laser source transmission system 100 to achieve the same technical advantages, but the present disclosure is not limited thereto.

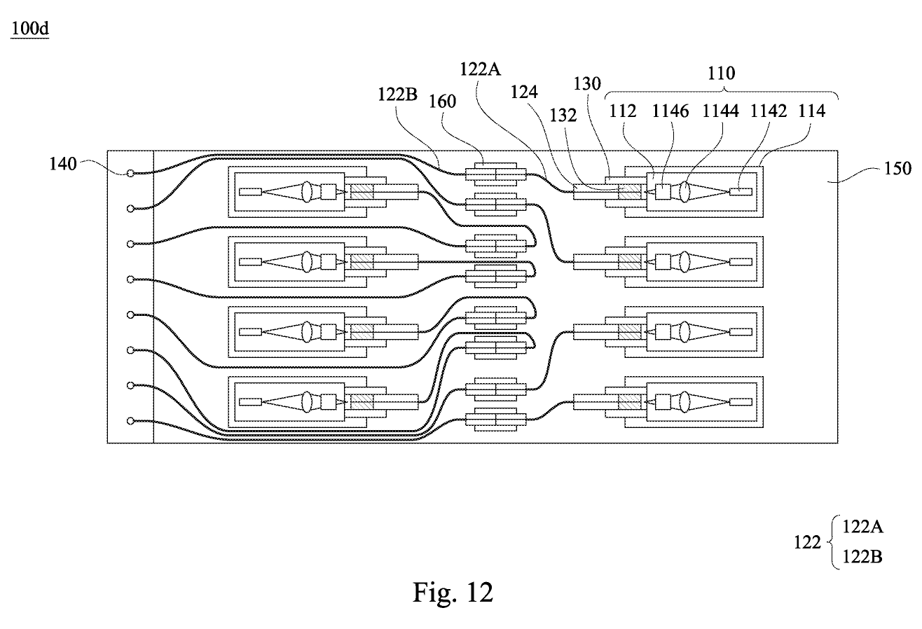

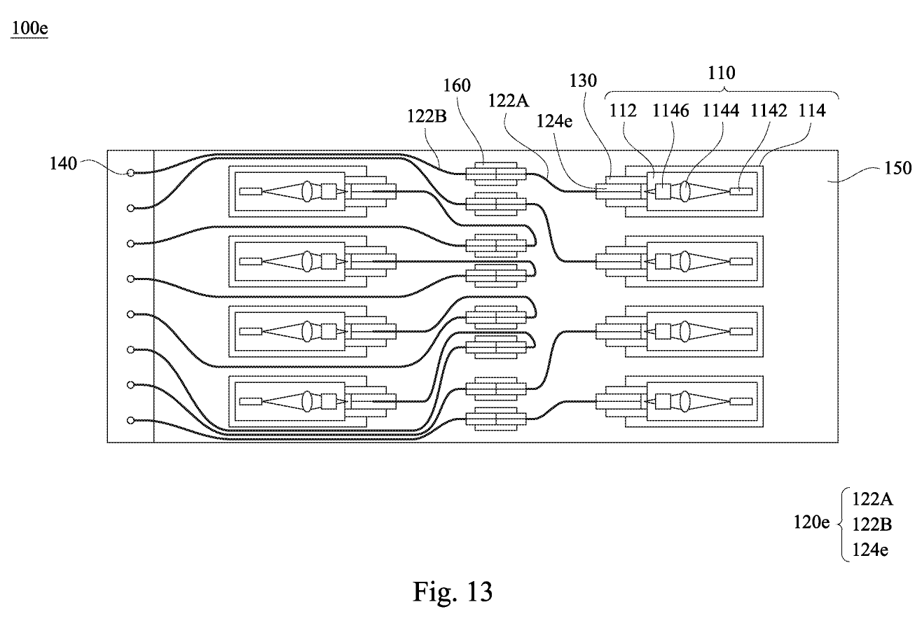

FIG. 10 is a schematic diagram of the cylindrical enclosing member 124c in FIG. 9 before engaged to the adaptor 130. FIG. 11 is a schematic diagram of the cylindrical enclosing member 124c in FIG. 10 after engaged to the adaptor 130. In the present embodiment, the cylindrical enclosing member 124c is engaged to the adaptor 130 and is fixed relative to the light emitting assembly 110 after optimizing optical coupling intensity and polarization extinction ratio, and therefore no pluggable function is reserved. It can also form an independent configuration of the light emitting assembly to improve the flexibility of the packaging component.

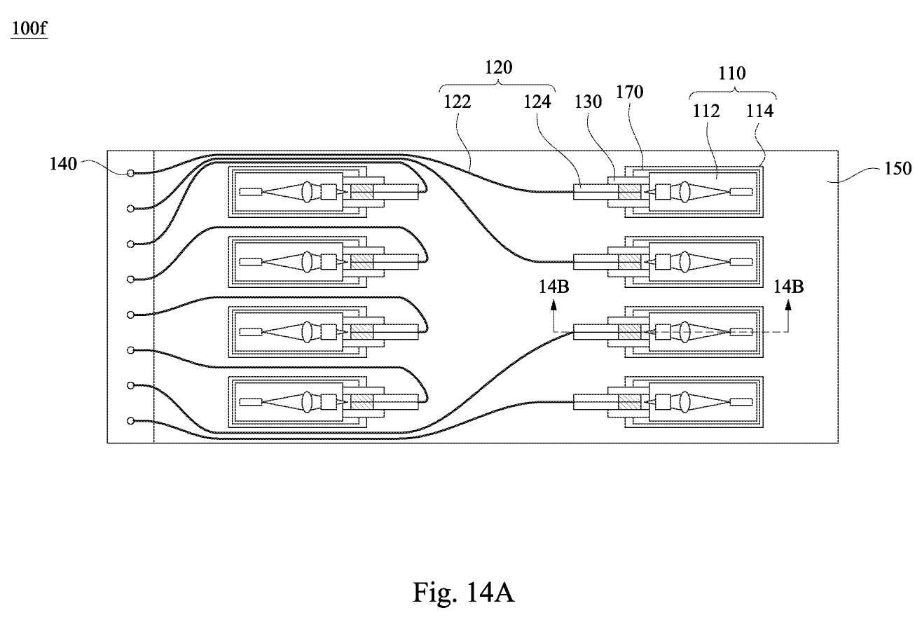

FIG. 12 is a schematic diagram of an external laser source transmission system 100d according to another embodiment of the present disclosure. The external laser source transmission system 100d is similar to the external laser source transmission system 100 in FIG. 1A, and the difference is that the external laser source transmission system 100d also includes multiple relay ports 160. Both ends of each relay port 160 have a structure similar to the cylindrical enclosing member 124, and are configured to connect two polarization-maintaining fibers 122 in series. One of the polarization-maintaining fibers 122A connects the relay port 160 and the light emitting assembly 110, and the other polarization-maintaining fiber 122B connects the relay port 160 and the optical connecting element 140. With such design, when abnormal signal of the polarization-maintaining fiber 122 occurs, only the light emitting assembly 110 or the optical connecting element 140 need to be replaced. In addition, the relay ports 160 can also provide further alignment between the optical axis direction FA and the optical polarization direction LP (see FIG. 5).

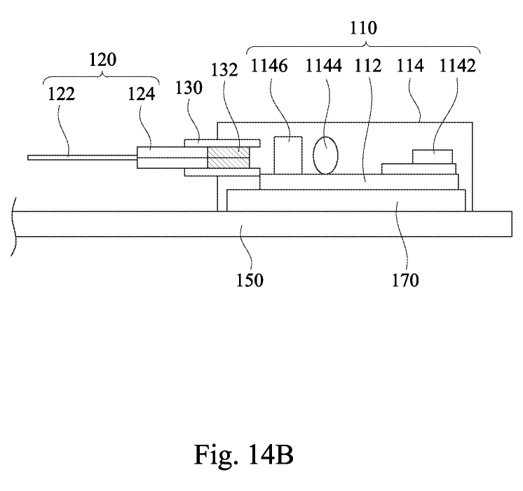

FIG. 13 is a schematic diagram of an external laser source transmission system 100e according to another embodiment of the present disclosure. The external laser source transmission system 100e is similar to the external laser source transmission system 100d in FIG. 12, and the difference is that the cylindrical enclosing member 124e of the polarization-maintaining fiber assembly 120e is the aforementioned fiber stub. The external laser source transmission system 100e has the same technical advantages as the external laser source transmission system 100d in FIG. 12, and will not be described again hereinafter

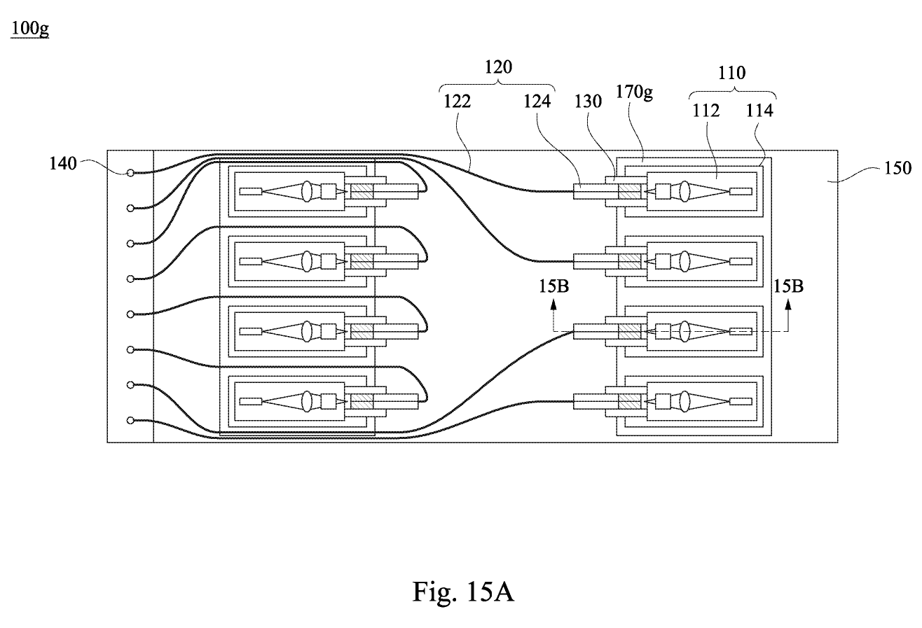

FIG. 14A is a schematic diagram of an external laser source transmission system 100f according to another embodiment of the present disclosure. FIG. 14B is a cross-sectional view taken along the line 14B-14B in FIG. 14A. The external laser source transmission system 100f is similar to the external laser source transmission system 100 in FIG. 1A, and the difference is that the external laser source transmission system 100f further includes multiple thermal cooling elements 170 respectively located within light emitting assemblies 110, but the present disclosure is not limited thereto. In other embodiments, the thermal cooling elements 170 may be located outside each of light emitting assemblies 110. With such design, the thermal cooling elements 170 are independent from each other, maintaining the flexibility of independent configuration of each of light emitting assemblies 110. The external laser source transmission system 100f has the same technical advantages as the external laser source transmission system 100 of FIG. 1A, and will not be described again hereinafter.

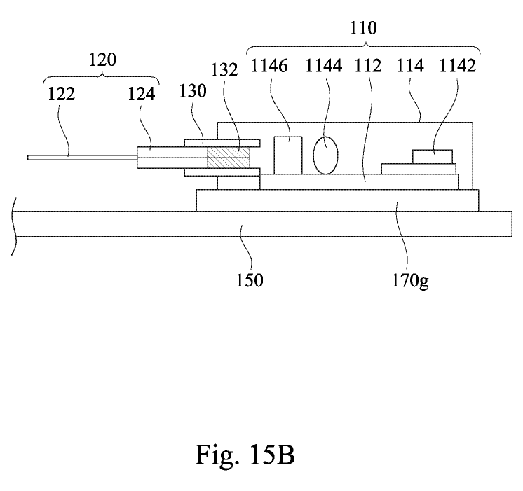

FIG. 15A is a schematic diagram of an external laser source transmission system 100g according to another embodiment of the present disclosure. FIG. 15B is a cross-sectional view taken along the line 15B-15B in FIG. 15A. The external laser source transmission system 100g is similar to the external laser source transmission system 100f in FIG. 14A, and the difference is that the thermal cooling element 170g of the external laser source transmission system 100g is at the same time located below multiple light emitting assemblies 110. In the present embodiment, four light emitting assemblies 110 are located on a single thermal cooling element 170g, but the present disclosure is not limited thereto. The external laser source transmission system 100g has the same technical advantages as the external laser source transmission system 100f in FIG. 14A, and will not be described again hereinafter.

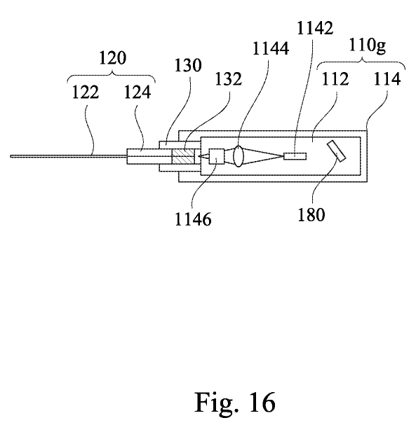

FIG. 16 is a schematic diagram of an external laser source transmission system according to another embodiment of the present disclosure. A single light emitting assembly 110g, a polarization-maintaining fiber assembly 120, and an adaptor 130 are demonstrated herein as examples. The light emitting assembly 110g is similar to the light emitting assembly 110 shown in FIG. 1A, and the difference is that the light emitting assembly 110g also includes a monitoring photodiode (MPD) 180 located on a side of the laser 1142 away from the lens 1144 to monitor the operating status of the laser 1142 in real time.

The following description will explain the manufacturing method of the external laser source transmission system 100 shown in FIG. 1A. It is noted that the component connections, materials, and functions already described will not be repeated.

Reference is made to FIG. 1A first. In the manufacturing method of the external laser source transmission system 100, a light emitting assembly 110 is formed by molding the substrate 112 and the laser 1142, the lens 1144, and the isolator 1146 placed on the substrate 112 with a molding element 114.

Reference is made to FIG. 2, the manufacturing method of the external laser source transmission system 100 continues to mounting the first end 1222 of the polarization-maintaining fiber 122 in the cylindrical enclosing member 124. In the present embodiment, a ferrule is used to wrap the first end 1222 of the polarization-maintaining fiber 122.

Reference is made to FIG. 1A. In the present embodiment, the manufacturing method of the external laser source transmission system 100 continues to coupling the second end 1224 of the polarization-maintaining fiber 122 to the optical connecting element 140. In other embodiments, reference is made to both FIG. 1A and FIG. 12, the path of coupling the second end 1224 of the polarization-maintaining fiber 122 and the optical connecting element 140 may further include a relay port 160 configured to connect two polarization-maintaining fibers 122 in series. One polarization-maintaining fiber 122A connects the relay port 160 and the light emitting assembly 110, and the other polarization-maintaining fiber 122B connects the relay port 160 and the optical connecting element 140.

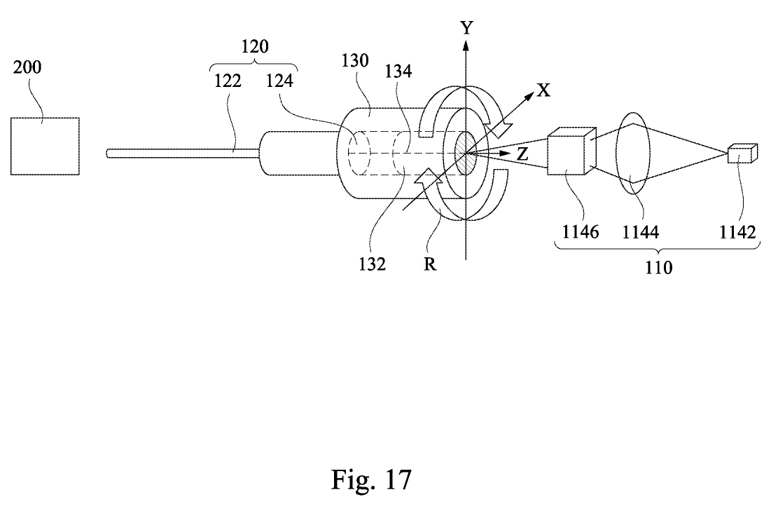

FIG. 17 is a schematic diagram of the step of connecting the polarization-maintaining fiber assembly 120 and the light emitting assembly 110 in FIG. 1A. Reference is made to FIG. 17 and FIG. 5 simultaneously. The manufacturing method of the external laser source transmission system 100 continues to connecting the light emitting assembly 110 and the cylindrical enclosing member 124 through the adaptor 130. In this step, the cylindrical enclosing member 124 of the polarization-maintaining fiber assembly 120 is first mounted into the adaptor 130. Then, the adaptor 130 together with the polarization-maintaining fiber assembly 120 are moved relative to the light emitting assembly 110 in the first direction X, the second direction Y, and the third direction Z. The laser light travels in the opposite direction of the third direction Z. The first direction X, the second direction Y, and the third direction Z are perpendicular to each other. The optical coupling intensity after the laser light passes through the polarization-maintaining fiber assembly 120 can be adjusted and detected by the detector 200 by moving the adaptor 130 relative to the light emitting assembly 110, thereby determining the optimal position of the adaptor 130 and optimizing the optical coupling intensity.

After optimizing optical coupling intensity, the manufacturing method of the external laser source transmission system 100 continues to rotating the cylindrical enclosing member 124 relative to the circular inner wall 1302 of the adaptor 130. Taking the rotation direction R as an example, the optical axis direction FA of the polarization-maintaining fiber 122 is aligned with the optical polarization direction LP of the laser 1142 (see FIG. 3), thereby optimizing polarization extinction ratio.

Reference is made to FIG. 1A, the multiple external laser source transmission modules 1002 assembled through the above steps are placed on the system substrate 150. Since the external laser source transmission modules 1002 disclosed herein are all independent from each other, the substrate 112 of each light emitting assembly 110 can be placed on the system substrate 150 in different placement orientations. As such, it can increase the flexibility of deposition and reduces the system area. For example, in the embodiment of FIG. 1A, four external laser source transmission modules 1002 are placed facing left side, and another four groups are placed facing right side.

In conventional methods, multiple modules are relatively fixed to each other, and multiple light emitting assemblies and multiple optical fibers can only be assembled one-time with single orientation. In addition, it is required to replace the entire module when damage to any component occurs, resulting in high assembly difficulty and difficulty in improving yield.

The assembly process of each external laser source transmission module 1002 disclosed herein is modular and operates independently, and therefore mass packaging and production are available. Furthermore, the laser emission can be monitored in real time during assembly process to optimize optical coupling intensity and polarization extinction ratio, and specific damaged components can be replaced. Such design is beneficial for assembly convenience and yield.

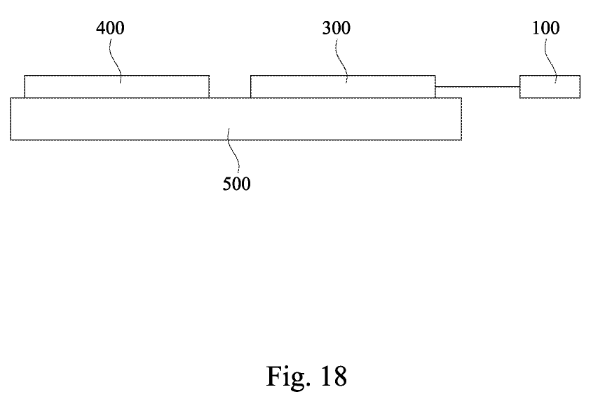

FIG. 18 is a schematic diagram of an external laser source transmission system 100 connected to a silicon photonic integrated circuit 300 according to an embodiment of this disclosure. Reference is made to FIG. 1A, an optical connecting element 140 is configured to couple the emitting light assembly 110, the polarization-maintaining fiber assembly 120, and the adaptor 130 to the silicon photonic integrated circuit 300. The silicon photonic integrated circuit 300 is disposed on a substrate 500 and electrically connected to an application-specific integrated circuit (ASCI) 400.

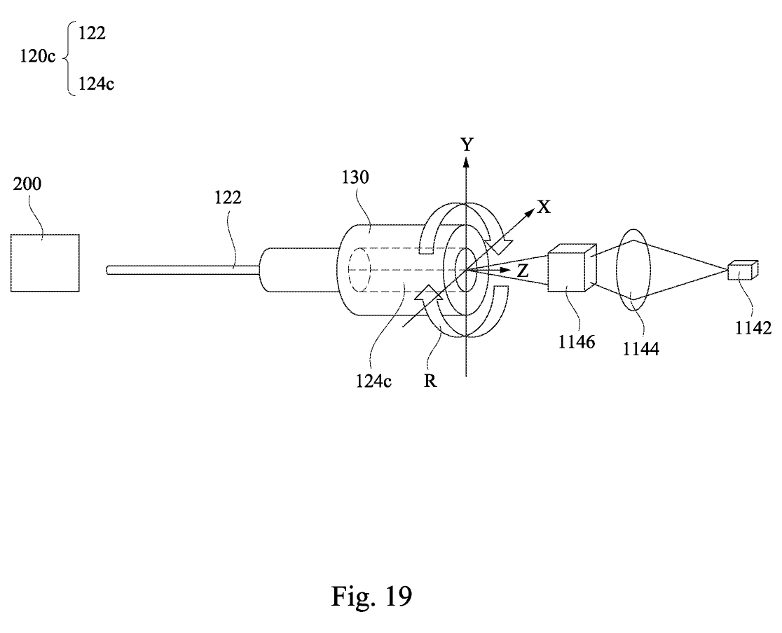

FIG. 19 is a schematic diagram of the step of connecting the polarization-maintaining fiber assembly 120c and the light emitting assembly 110 in FIG. 9. In the present embodiment, the adaptor 130 connects the emitting light assembly 110 and the polarization-maintaining fiber assembly 120c with the same method described above. In the present embodiment, after the cylindrical enclosing member 124c is mounted into the adaptor 130, the cylindrical enclosing member 124c and the adaptor 130 move together in the first direction X, the second direction Y, and the third direction Z, and rotate along the rotation direction R to simultaneously optimize optical coupling efficiency and polarization extinction ratio.

As described above, the external laser source transmission system disclosed herein utilizes a cylindrical enclosing member that can rotate relative to the adaptor to rotate the polarization-maintaining fiber relative to the adaptor, thereby aligning the optical axis direction of the polarization-maintaining fiber with the optical polarization direction of the laser and optimizing polarization extinction ratio. Rotating the larger cylindrical enclosing member can reduce the difficulty of adjusting the optical axis direction of the polarization-maintaining fiber. Furthermore, the adaptor along with the polarization-maintaining fiber assembly can move relative to the emitting light assembly to optimize optical coupling intensity. Since the external laser source transmission modules disclosed herein are all independent from each other, the light emitting assemblies can be placed on the system substrate in different placement orientations. As such, it can increase the flexibility of placement positions and reduce the system area. The assembly process of the external laser source transmission module disclosed herein is modular and operates independently, and therefore mass packaging and production are available. During assembly process, the laser emission can be detected in real time to optimize optical coupling intensity and polarization extinction ratio, and specific damaged components can be replaced. Such design is beneficial for assembly convenience and yield.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An external laser source transmission system, comprising:
a plurality of external laser source transmission modules, and each of the plurality of external laser source transmission modules comprises:
a light emitting assembly comprising a substrate and a molding element, wherein the substrate is configured to carry a laser, a lens and an isolator, and the molding element is configured to mold the laser, the lens, the isolator, and the substrate;
a polarization-maintaining fiber assembly engaged with the light emitting assembly, wherein the polarization-maintaining fiber assembly comprises a polarization-maintaining fiber and a cylindrical enclosing member; and
an adaptor engaged with the light emitting assembly and the cylindrical enclosing member, wherein the cylindrical enclosing member rotates relative to the adaptor to optimize polarization extinction ratio;
a system substrate configured to carry the external laser source transmission modules; and
a plurality of optical connecting elements coupled to the polarization-maintaining fibers of the plurality of external laser source transmission modules.

2. The external laser source transmission system of claim 1, further comprising:
a silicon photonic integrated circuit coupled to the plurality of optical connecting elements.

3. The external laser source transmission system of claim 1, wherein the cylindrical enclosing member is a ferrule or a fiber stub.

4. The external laser source transmission system of claim 1, wherein the adaptor comprises a circular inner wall, the cylindrical enclosing member is pluggably mounted in the circular inner wall and rotates relative to the adaptor to align an optical axis direction of the polarization-maintaining fiber with a polarization direction of the laser.

5. The external laser source transmission system of claim 1, wherein the adaptor comprises a circular outer wall, the adaptor drives the cylindrical enclosing member to rotate or move together to optimize optical coupling intensity and polarization extinction ratio.

6. The external laser source transmission system of claim 1, wherein the adaptor further comprises a fiber stub abutting against the cylindrical enclosing member.

7. The external laser source transmission system of claim 1, wherein the light emitting assembly also includes a can-shaped package encapsulating the laser and the lens.

8. The external laser source transmission system of claim 1, further comprising:
a plurality of relay ports, wherein each of the plurality of relay ports is connected in series with two of the polarization-maintaining fibers of the external laser source transmission modules respectively, one of the polarization-maintaining fibers is connected to the said relay port and one of the light emitting assemblies, and the other polarization-maintaining fiber is connected to the said relay port and one of the plurality of optical connecting elements.

9. The external laser source transmission system of claim 1, wherein the optical connecting elements can be Multi-fiber Push-on connector (MPO), Multi-fiber Termination Push-on (MTP), or MT stub.

10. The external laser source transmission system of claim 1, wherein the light emitting assemblies of the plurality of external laser source transmission modules have different placement orientations.

11. A manufacturing method of an external laser source transmission system, comprising:
mounting at least one external laser source transmission module, comprising:
forming a light emitting assembly comprising molding a substrate with a laser, a lens, and an isolator on the substrate through a molding element;
mounting a first side of at least one polarization-maintaining fiber in a cylindrical enclosing member; and
coupling a second end of the at least one polarization-maintaining fiber in an optical connecting element; and
engaging the light emitting assembly and the cylindrical enclosing member through an adaptor, wherein the cylindrical enclosing member rotates relative to the adaptor to optimize polarization extinction ratio.

12. The manufacturing method of the external laser source transmission system of claim 11, further comprising:
coupling the optical connecting element to a silicon photonic integrated circuit.

13. The manufacturing method of the external laser source transmission system of claim 11, wherein mounting a first side of the at least one polarization-maintaining fiber in a cylindrical enclosing member further comprises:
wrapping a first side of the at least one polarization-maintaining fiber by a ferrule or a fiber stub.

14. The manufacturing method of the external laser source transmission system of claim 11, wherein the adaptor comprises a circular inner wall, and engaging the light emitting assembly and the cylindrical enclosing member through the adaptor further comprises:
mounting the cylindrical enclosing member in the circular inner wall of the adaptor; and
rotating the cylindrical enclosing member relative to the adaptor to align an optical axis direction of the polarization-maintaining fiber with a polarization direction of the laser.

15. The manufacturing method of the external laser source transmission system of claim 11, wherein the adaptor comprises a circular inner wall, and engaging the light emitting assembly and the cylindrical enclosing member through an adaptor further comprises:
mounting the cylindrical enclosing member in the circular inner wall of the adaptor; and
moving the adaptor along with the at least one polarization-maintaining fiber relative to the light emitting assembly to optimize the optical coupling intensity.

16. The manufacturing method of the external laser source transmission system of claim 15, wherein the adaptor comprises a circular outer wall, and engaging the light emitting assembly and the cylindrical enclosing member through an adaptor further comprises:
rotating the adaptor along with the cylindrical enclosing member relative to the light emitting assembly to optimize the optical coupling intensity.

17. The manufacturing method of the external laser source transmission system of claim 11, wherein mounting the at least one external laser source transmission module further comprises:
encapsulating the laser and the lens through a can-shaped package.

18. The manufacturing method of the external laser source transmission system of claim 11, wherein mounting the at least one external laser source transmission module further comprises:
abutting against the cylindrical enclosing member through a fiber stub deposited in the adaptor.

19. The manufacturing method of the external laser source transmission system of claim 11, wherein a number of the at least one polarization-maintaining fiber is two, and mounting the at least one external laser source transmission module further comprises:
connecting the polarization-maintaining fibers in series through a relay port respectively, wherein one of the polarization-maintaining fibers is connected to the relay port and the light emitting assembly, and the other polarization-maintaining fiber is connected to the relay port and the optical connecting element.

20. The manufacturing method of the external laser source transmission system of claim 11, wherein a number of the at least one external laser source transmission module is plural, and the manufacturing method of the external laser source transmission system further comprises:
depositing the external laser source transmission module on a system substrate, wherein the light emitting assemblies of the external laser source transmission modules have different placement orientations.
